(19) United States
(12) Patent Application Publication
(10) Pub. No.: US 2017/0373407 A1
(43) Pub. Date: Dec. 28, 2017

(54) Flush earth ground connector

(71) Applicant: Michael James Tobin, Warner Robins, GA (US)

(72) Inventor: Michael James Tobin, Warner Robins, GA (US)

(21) Appl. No.: 15/193,324

(22) Filed: Jun. 27, 2016

(51) Int. Cl. H01R 4/66; B64D 45/02; B64F 1/36; H01R 13/62

(52) U.S. Cl. CPC H01R 4/66; H01R 13/6205; B64D 45/02; B64F 1/362

(57) ABSTRACT

This invention is a connecting device for earth grounding aircraft and aerospace equipment. The connector assembly has two parts, an upper and lower. The upper part of the connector provides a receptacle to secure an aerospace chassis ground wire. An internal magnet holds the upper part to the lower part. The lower part is secured in the ground and is flush with the surrounding surface. It is subterraneously connected to a ground rod. Upon disconnection and removal of the upper part, the lower part stays in place and provides a smooth and unencumbered surface.

### CROSS REFERENCES TO RELATED APPLICATIONS

Not Applicable

### STATEMENT REGARDING FEDERALLY SPONSORED RESEARCH Not Applicable

### REFERENCE TO APPENDIX

Not Applicable

### FIELD OF INVENTION

The presented invention relates to the aviation and aerospace industry and the method of providing an electrical earth ground for aircraft, aerospace vehicles, and associated support equipment.

### BACKGROUND OF THE INVENTION

Current aircraft and aircraft support equipment electrical ground points are grounding rods driven through the pavement surface. Alligator style clamps are then attached to the rod with the other end of the cable attached to a chassis connector. The grounding rod is usually recessed below the surface of the concrete so it does not protrude. To access the recessed rod the concrete around the rod is chiseled or poured to create a divot. This recessed divot accumulates foreign objects such as screws, nuts, and bolts. Foreign object damage can have devastating effects on aircraft and aircraft engines resulting in possible loss of life and equipment. This presented invention, the flush earth ground connector, eliminates the possibility of foreign objects accumulating at the grounding point due to the fact that bottom portion of the connector remains flush with the surrounding surface leaving the area free from protrusions or divots.

### SUMMARY OF THE INVENTION

The flush earth ground connector is a connecting device to statically ground aircraft, aerospace vehicles, and aerospace support equipment. Since it is a connector it has two separating components that, when brought together, form a conductive connection. The two major components are the upper and the lower portion.

The lower portion of the system is a metal, semispherical, cylinder type object with the flat surface facing up and mounted so that it is flush with the surrounding surface. The bottom has an area that is drilled and tapped to allow for a long threaded screw type object to allow it to be securely mounted into the ground or surrounding surface. The lower portion is then connected by conductive wire and/or clamp to the grounding rod. After the lower portion is installed the area is filled with concrete or suitable material flush with the surrounding area. This prevents foreign objects from collecting or gathering around the grounding point.

The upper portion of the system is a cylindrical disk type design with a handle and an internal magnet. The internal magnet secures the upper and lower portion together allowing for the connection. To accommodate the magnet the upper portion is designed into two halves. The bottom half is a metal disk that has the center area hollowed for placement of the magnet. It is also milled and threaded near the edge of the disk so the top half can be screwed into the bottom half. The top half is similarly disk shaped with threads protruding so it can be connected to the bottom half. The top half of the plug also incorporates a handle. The handle has an opening to allow for a standard aerospace grounding cable to be inserted and secured by two set screws.

### BRIEF DESCRIPTION OF THE SEVERAL VIEWS OF THE DRAWING

A preferred embodiment of the invention, illustrative of the best mode in which the applicant has contemplated applying the principles, is set forth in the following description and is shown in the drawings and is particularly and distinctly pointed out and set forth in the appended claims.

The disclosure will be better understood and objects other than those set forth above will become apparent when consideration is given to the following detailed description thereof. Such description makes reference to the drawings wherein:

FIG.1 is a perspective view of an installed into the earth, coupled, and wired to both ground and chassis assembly according to an embodiment of the disclosure.

FIG. 2A is a perspective view of the bottom portion of the connector according to an embodiment of the disclosure.

FIG. 2B is a side view of the bottom portion of the connector mounted onto an auger according to an embodiment of the disclosure.

FIG. 3A is a top view of the upper portion of the connector according to an embodiment of the disclosure.

FIG. 3B is a side view of the upper portion of the connector according to an embodiment of the disclosure.

FIG. 3C is a rotated side view of the upper portion of the connector according to an embodiment of the disclosure.

FIG. 3D is a bottom view of the upper portion of the connector according to an embodiment of the disclosure.

FIG. 4 is an exploded view of the upper portion of the connector showing the internal magnet according to an embodiment of the disclosure.

### DETAILED DESCRIPTION OF THE INVENTION

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding field, background, brief summary, or the following detailed description. Many modifications are conceivable without departing from the spirit of the inventive concept as defined in the appended Claims.

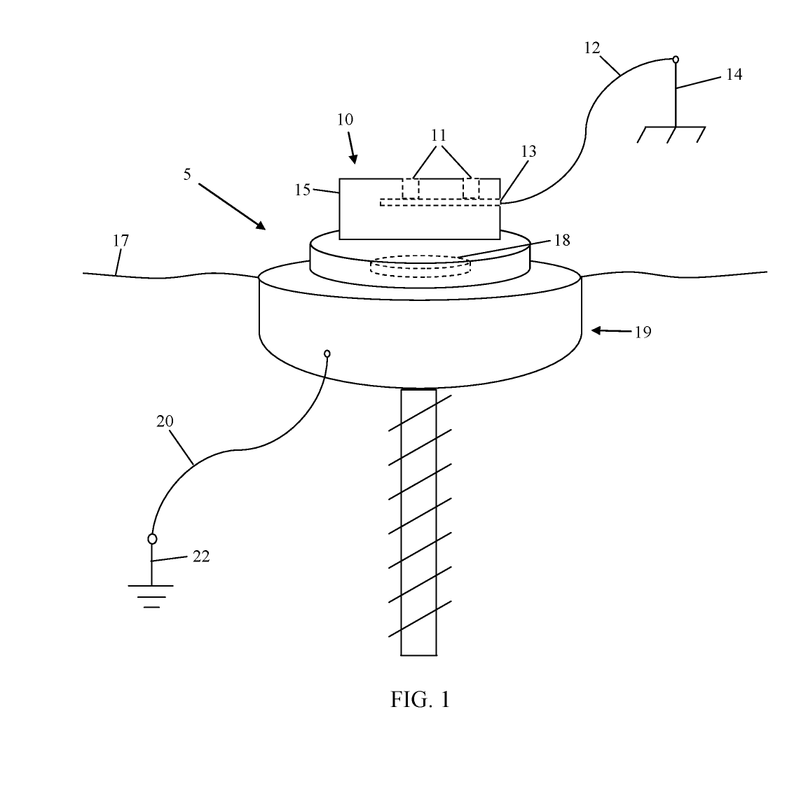

Note that the standard and universally accepted symbols for earth ground and chassis ground are used in FIG. 1 items 22 and 14 respectively.

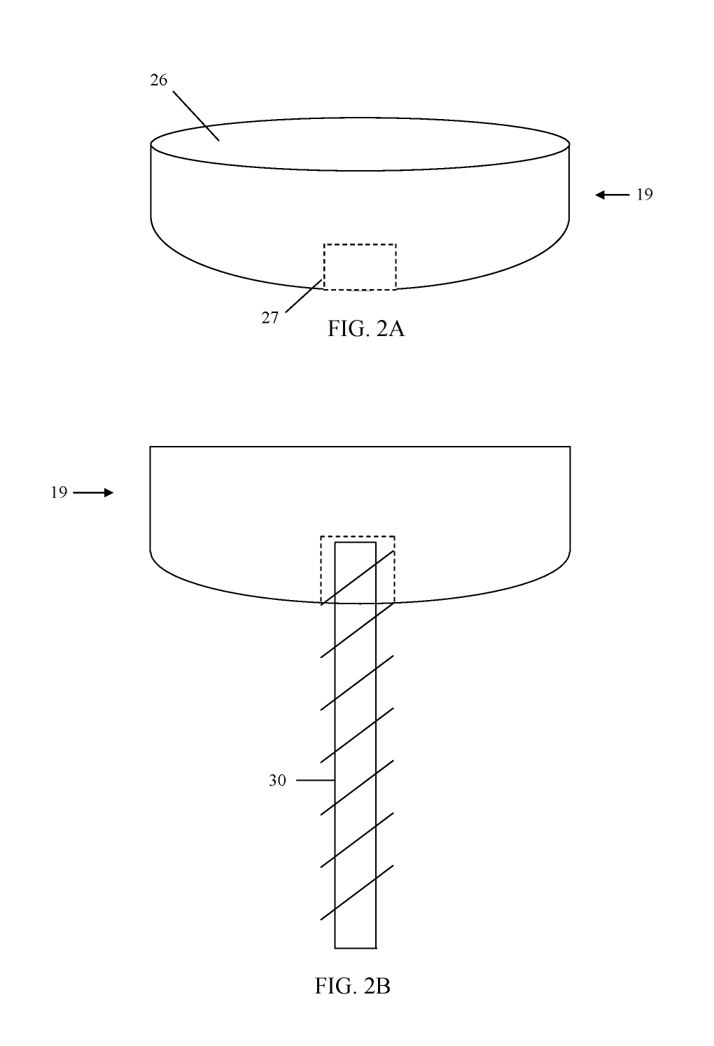

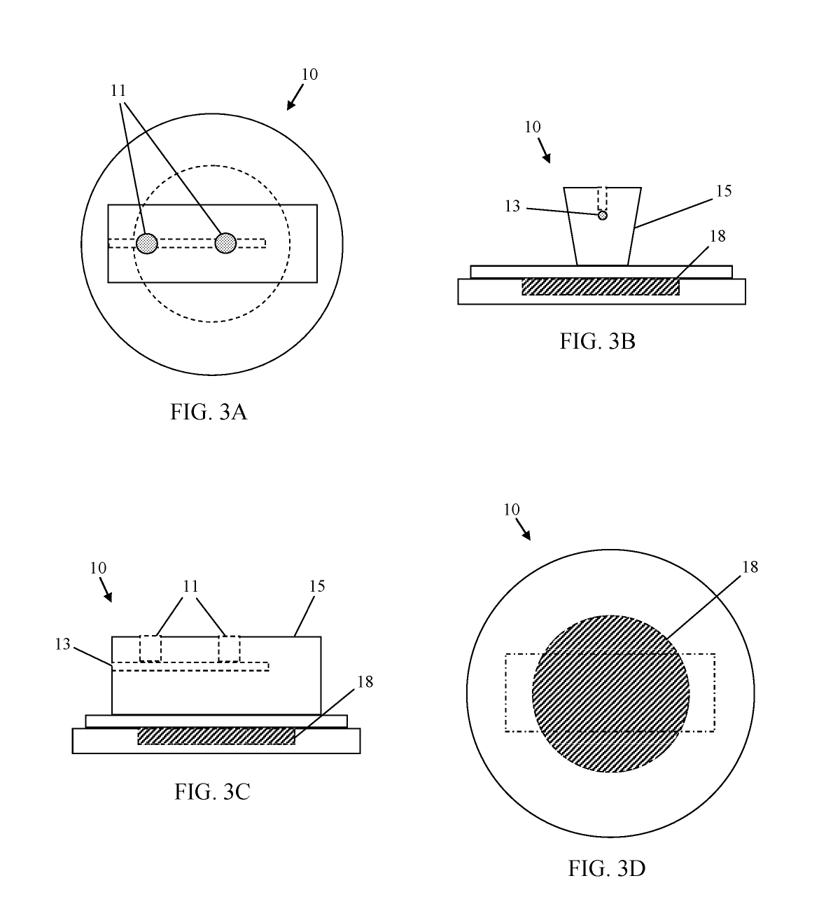

As best illustrated in FIGS. 1 through 6, the flush earth ground connector generally comprises of two parts. An upper portion 10 and lower portion 19. Male and female connotation describing the connector parts does not apply due to the fact that the connecting bodies are flush and smooth as is the purpose of the embodiment. Therefore, upper portion and lower portion will be used to describe the two parts of the connector assembly 5. The upper portion 10 is attracted to the lower portion 19 by an internal magnet 18. The magnet 18 secures the upper 10 and lower portion 19 together to allow for electrical flow through the connector assembly 5.

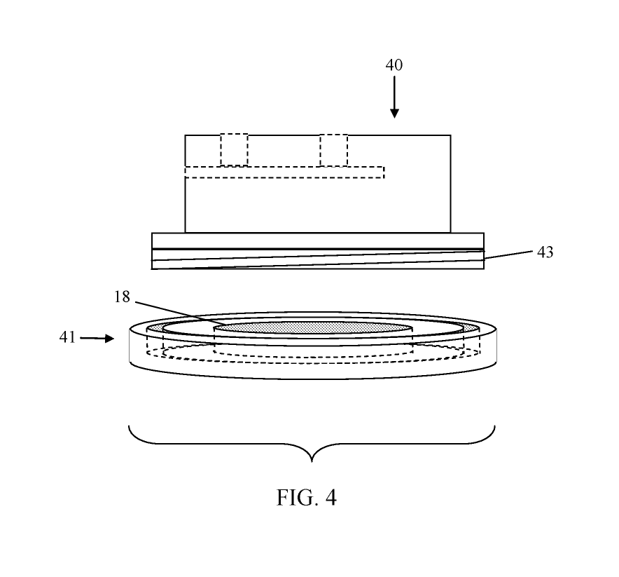

The upper portion 10 is of cylindrical disk shape with a handle 15 of rectangular shape protruding from the top. The handle 15 contains and opening 13 to accept a standard aerospace static grounding wire 12. The grounding wire 12 is secured by two set screws 11 contained within the handle 15 of the upper portion. Upon insertion of the ground wire 12 the two set screws 11 are tightened to hold the wire 12 in place and allow for electrical conductivity. As shown in FIG. 4, an exploded view of the upper portion, of the present embodiment describes two separate components, an upper half 40 and lower half 41 that combine together through threading 43 to secure a magnet 18 internally.

The lower portion 19 of the connector is a semispherical, cylinder type shape. The top surface 26 of the lower portion is flat and sits flush with the surrounding surface 17. The flat surface 26 of the lower portion 19 allows for placement of the upper portion of the connector 10. The bottom of the lower portion 19 has a cylindrical hollowed space 27 to allow for mounting on to an auger 30. The lower portion 19 can also be mounted by alternative methods, not limited to but including, directly to an earth ground rod, a post, or otherwise secured to the surrounding surface 17. The lower portion 19 is connected to an earth ground 22 either directly or via cable 20 by securing it through a weld or clamp or similar attaching methods.

The coupled, flush earth ground connector 5 allows electrical static build up to be dissipated from the aerospace vehicle, equipment, or aircraft through the chassis connection 14, the aerospace ground wire 12, the upper portion of the connector 10, the bottom portion of the connector 19, the ground cable 20, to the earth ground rod 22. Upon removal of the upper portion of the connector 10, the bottom portion 19 remains flush with the surrounding surface 17 leaving the area free from protrusions or divots.

What is claimed is:

1. An aircraft, aerospace vehicle, and/or associated aeronautical or aerospace support equipment, flush to the surrounding surface, electrical earth grounding connector, with said connector assembly comprising of: a bottom portion of the connector that is flush to the surrounding surface that is connected, subterraneously, to a ground rod; an upper portion of the connector that is attracted to the bottom portion through an incorporated magnet, with a handle that contains an opening with set screws to accept an aircraft, aerospace, and/or support equipment static grounding cable.

2. The assembly according to claim 1, wherein: the bottom portion of the connector has a semispherical, cylinder type shape to withstand the compression forces of large aircraft and aerospace vehicles.

3. The assembly according to claim 2, wherein: the bottom portion of the connector has sufficient metallurgical composition to be electrically conductive.

4. The assembly according to claim 2, wherein: the bottom portion of the connector has sufficient metallurgical composition to be attracted to magnets.

5. The assembly according to claim 2, wherein: the bottom portion of the connector is mounted to an auger or screw type mount, or to the surrounding surface, or attached directly to a ground rod.

6. The assembly according to claim 2, wherein: a ground cable is welded, clamped, bolted, or otherwise secured to the bottom portion of the connector when not directly attached to a ground rod.

7. The assembly according to claim 1, wherein: the upper portion of the connector is of disk shape with a vertical handle that houses set screws to secure an aircraft, aerospace, or support equipment ground cable.

8. The assembly according to claim 7, wherein: the upper portion of the connector contains a magnet that produces enough attraction to secure it to the bottom portion of the connector but still allows removal by hand strength.

9. The assembly according to claim 7, wherein: the upper portion of the connector has sufficient metallurgical composition to be electrically conductive.

10. The assemblies according to claims 2 and 7, wherein: when brought together, forms an electrically conductive connection.
